(19) United States
(12) Patent Application Publication
(10) Pub. No.: US 2013/0239656 A1
(43) Pub. Date: Sep. 19, 2013

(54) Gas Chromatograph

(71) Applicants: Aosheng Wang, Eden Prairie, MN (US); Ray Dean Shepherd, Tulsa, OK (US); Christoph Klawun, Bartlesville, OK (US)

(72) Inventors: Aosheng Wang, Eden Prairie, MN (US); Ray Dean Shepherd, Tulsa, OK (US); Christoph Klawun, Bartlesville, OK (US)

(73) Assignee: Siemens Aktiengesellschaft, Muenchen (DE)

(21) Appl. No.: 13/420,233

(22) Filed: Mar. 14, 2012

(51) Int. Cl. G01N 30/02

(52) U.S. Cl. 73/23.4

(57) ABSTRACT

A gas chromatograph comprising a separation column for separating components of a sample of a gas mixture fed through the separation column by a carrier gas, a thermal conductivity detector including a sensing element arranged downstream from the separation column and configured to detect the separated components in a non-destructive manner and to generate a detector signal in response the detected components, an evaluation unit for evaluating the detector signals to determine concentrations of the detected components, and a further thermal conductivity detector including a further sensing element arranged immediately downstream or upstream from the thermal conductivity detector and configured to detect the separated components and to generate a further detector signal in response to the detected components, where the evaluation unit is configured to compare the detector signal with the further detector signal to recognize and signal a loss of or improper detection by the thermal conductivity detector.

### BACKGROUND OF THE INVENTION

1. Field of the Invention

The invention relates to a gas chromatograph for analyzing a gas mixture comprising at least one separation column for separating components of a sample of the gas mixture which is fed through the separation column by a carrier gas; a thermal conductivity detector which has a sensing element arranged downstream from the separation column and which further is adapted to detect the separated components in a non-destructive manner and to generate a detector signal in response to each of the detected components; and an evaluation unit for evaluating the detector signals to determine the concentrations of the detected components.

2. Description of the Related Art

U.S. 2005/0123452 A1 discloses a gas chromatograph. The known gas chromatograph has several separation columns coupled directly or by a valveless controllable changeover in series. Each separation column is followed by an inline thermal conductivity detector for detecting gas components sufficiently separated up to that point. The thermal conductivity detectors have micro-machined sensing elements in the form of micro-machined devices with heated filaments along the axis of a tubular channel. The inner diameters of the channels correspond at least approximately to those of the separation columns so that the sample of the gas mixture is not disturbed at the detector sites. Each sensing element preferably has two inline filaments. These two filaments are diagonally arranged in a Wheatstone bridge together with two filaments of the sensing element of another thermal conductivity detector through which, at the time of the detection, the carrier gas flows.

Process gas chromatographs, as above-mentioned, are often used to monitor a chemical or petrochemical process to ensure the stability of the process and/or the quality of the products from the process. Thermal conductivity detectors are commonly used in process gas chromatographs to monitor flows and to acquire chromatograms. However, a thermal conductivity detector can fail unexpectedly during operation and such failure may require an unexpected shut-down of the process being monitored, which can be very expensive.

### SUMMARY OF THE INVENTION

It is therefore an object of the invention to improve the reliability and confidentiality of the measurements.

According to the invention this object, among other advantages, is achieved in that the gas chromatograph of the above-mentioned type further comprises: at least one further thermal conductivity detector which has a further sensing element arranged immediately downstream or upstream the thermal conductivity detector and which is adapted to detect the separated components and to generate a further detector signal in response to each of the detected components; and the evaluation unit being further adapted to compare the detector signal with the further detector signal to recognize and signal a loss of or improper detection by the thermal conductivity detector.

The gas chromatograph according to the invention takes advantage of redundant measurements in order to provide a system that tolerates the loss of some of the individual measurements so that a failure in one of the thermal conductivity detectors can be detected and reported as a warning while remaining thermal conductivity detectors can still provide adequate process measurements. Using this redundant measurement system, a process shut-down may not be required to replace the failed detector. Even if a process shut-down is still required to replace the failed detector, the shut-down can be scheduled later to minimize the cost of the process shut-down. Depending on the process to be monitored, the increased analyzer cost due to the use of a redundant measurement system may well be justified by the reduced risk of unexpected process shut-downs.

It is known to use a thermal conductivity detector in series with a flame ionization detector for analyzing complex mixtures where different types of detectors are needed; however, the information provided by the two techniques is complimentary and not redundant and thus does not serve the purpose of the present invention. This is also true for thermal conductivity detectors with two inline filaments, which are commercially available and have been used in process gas chromatographs as the above-mentioned US 2005/0123452 A1 shows. In contrast to this, according to the invention, micro-machined devices with two inline filaments along the axis of a tubular channel may be preferably used while the two inline filaments belong to different redundant thermal conductivity detectors.

### BRIEF DESCRIPTION OF THE DRAWINGS

The invention will now be described in greater detail by way of example and with reference to the drawing figures in which:

FIG. 1 shows an exemplary embodiment of the gas chromatograph according to the invention; and

FIG. 2 shows an exemplary embodiment of two redundant thermal conductivity detectors.

### DETAILED DESCRIPTION OF THE PREFERRED EMBODIMENTS

In the following description, like reference numerals designate like parts or elements.

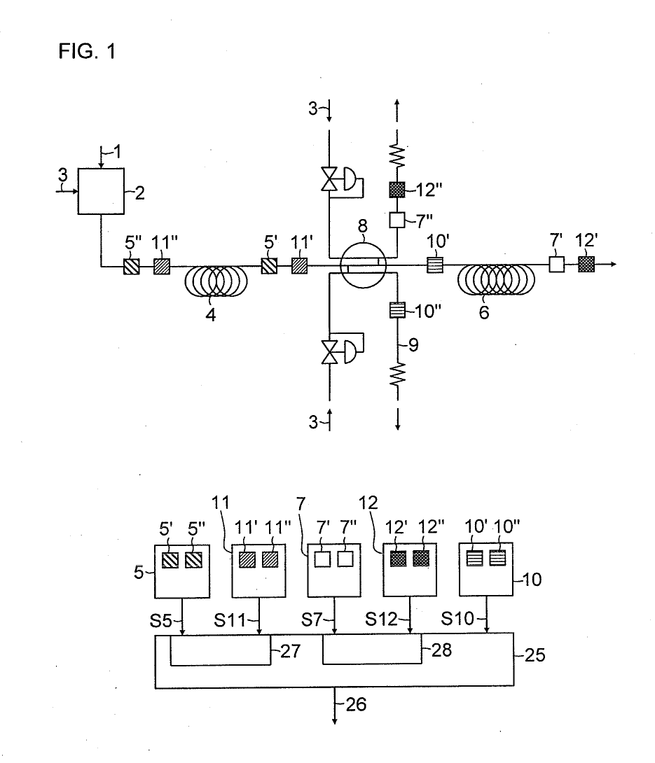

FIG. 1 shows a gas chromatograph for analyzing a gas mixture 1. A sample of the gas mixture 1, which has been removed from a technical process and treatment, is supplied to a dosing unit 2. The dosing unit 2 is used to inject a specified dose of the gas sample as a short and sharply delimited dosing plug into a carrier gas stream 3 at a predefined instant. The dose and the carrier gas are supplied to a separation column combination in which the gas components contained in the sample plug are separated and sequentially detected and quantitatively identified.

In the shown example, the separation column combination consists of a first separation column 4 followed by a sensing element 5′ of a first thermal conductivity detector (TCD) 5, and a second separation column 6 followed by a sensing element 7′ of a second TCD 7. The separation columns 4, 6 and the sensing elements 5′, 7′ are arranged in line in a series connection. A controllable changeover device 8 is arranged between the separation columns 4 and 6, in this case after the sensing element 5′ of the first TCD 5.

The first separation column 4 is configured to separate gas components such as higher hydrocarbons, which have higher retention times and which are detected by the first TCD 5.

The second separation column 6 is configured to separate gas components such as carbon dioxide or nitrogen, which have lower retention times and which are detected by the second TCD 7.

There may be certain gas components which must be prevented from reaching the second separation column 6 because they cannot or can only be removed by conditioning this separation column 6. For this reason, these unwanted gas components, after they exit from the first separation column 4, are discharged via a gas path 9 by means of the controllable changeover device 8. The changeover device 8 can be controlled as a function of the presence of the first one of the unwanted gas components at the sensing element 5′ of the first TCD 5 or a specified period following the detection of the last one of the gas components admissible for the second separation column 6. A sensing element 10′ of an additional TCD 10 is arranged in line between the changeover device 8 and the second separation column 6. This allows for recognizing faults in the adjustment of the changeover device 8 by comparing the measurements of TCDs 5 and 10.

After detection of all interesting gas components to be detected by the first TCD 5, the first separation column 4 is back-flushed with the carrier gas 3 via the controllable changeover device 8, such that all following gas components are removed from the first TCD 5 and the separation column 4.

To provide redundant measurement, the sensing elements 5′, 7′ of the TCDs 5, 7 are immediately followed by sensing elements 11′, 12′ of respective redundant TCDs 11, 12.

Each of the sensing elements 5′, 7′, 10′, 11′, 12′ cooperates with a partner sensing element 5″, 7″, 10″, 11″, 12″ through which the carrier gas 3 flows either continuously or at least at the time when a gas component is detected by the associated one of the sensing elements 5′, 7′, 10′, 11′, 12′.

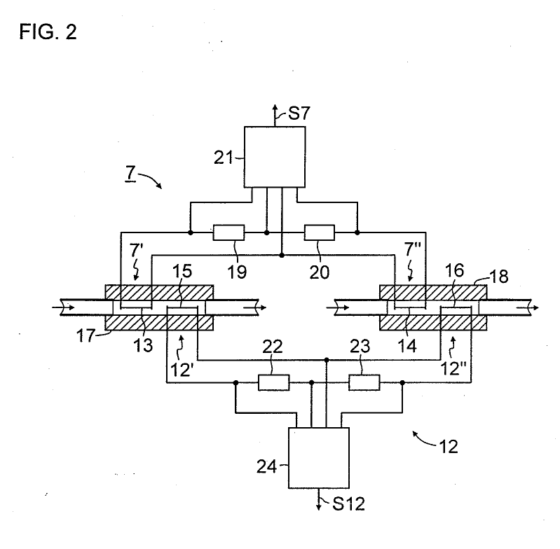

As FIG. 2 shows with the example of TCD 7 and redundant TCD 12, each sensing element 7′, 7″, 12′, 12″ has a heated filament 13, 14, 15, 16 which are arranged in pairs 13, 15 and 14, 16 in line in respective tubular channels 17, 18. Channel 17 forms a measurement gas path and channel 18 a reference path. The sensing elements 7′, 7″, or more precisely the filaments 13, 14, of TCD 7 are arranged in a Wheatstone bridge together with fixed resistors 19, 20 of a very low temperature coefficient. The Wheatstone bridge is supplied with a current from a detector circuit 21 at two opposite circuit points, and the voltage that occurs between the two other opposite circuit points is detected by the detector circuit 21 to generate a detector signal S7 of TCD 7.

The sensing elements 12′, 12″, or more precisely the filaments 15, 16, of the redundant TCD 12 are arranged in another Wheatstone bridge together with fixed resistors 22, 23 of a very low temperature coefficient. The Wheatstone bridge is supplied with a current from a detector circuit 24 at two opposite circuit points, and the voltage that occurs between the two other opposite circuit points is detected by the detector circuit 24 to generate a detector signal S12 of TCD 12.

As shown in FIG. 2, the sensing elements 7′, 12′ in the measurement gas path are preferably integrated in a single component or at least thermally coupled on a common substrate. The component is preferably micro-machined to keep the distance between the sensing elements 7′, 12′ or 7″, 12″ in the same flow path very small so that peak broadening in chromatograms of subsequent sensing elements can be minimized. The sensing elements 7″, 12″ in the reference path may be integrated in another component or otherwise thermally coupled. Preferably, all sensing elements 7′, 7″, 12′, 12″ of TCDs 7, 12 are attached to a same thermal block for a same constant ambient temperature.

As indicated in FIG. 1, the other TCDs 5, 10, 11 generate corresponding detector signals S5, S10, S11. The detector signals S5, S7, S10, S11, S12 are provided to an evaluation unit 25 for determining and outputting the concentrations 26 of the detected gas components. The evaluation unit 25 further includes comparing units 27, 28 for comparing the detector signals S5, S7 with the respective redundant detector signals S11, S12 to recognize and signal a loss of or improper detection by TCDs 5, 7.

The present invention may be embodied in other specific forms without departing from its spirit or essential characteristics. The described embodiments are to be considered in all respects only as illustrative and not restrictive. For example, the Wheatstone bridges shown in FIG. 2 are just classical constructions and there are several different approaches to construct a TCD bridge and several different methods to power and to operate one or more sensing elements in the bridge. In the embodiment of FIG. 1, TCD 10 has no redundant counterpart; however, it may be desirable and is within the scope of the present invention to provide for each TCD a redundant counterpart, regardless of whether it is used for detecting gas components, flow measurement or other purposes.

What is claimed is:

1. A gas chromatograph for analyzing a gas mixture (1) comprising:
at least one separation column (4, 6) for separating components of a sample of the gas mixture (1) which is fed through the separation column (4, 6) by a carrier gas (3);
a thermal conductivity detector (5, 7) which has a sensing element (5′, 7′) arranged downstream from the separation column (4, 6) and which further is adapted to detect the separated components in a non-destructive manner and to generate a detector signal (S5, S7) in response to each of the detected components; and
an evaluation unit (23) for evaluating the detector signals (S5, S7) to determine the concentrations of the detected components;
said gas chromatograph further comprising:
at least one further thermal conductivity detector (11, 12) which has a further sensing element (11′, 12′) arranged immediately downstream or upstream from the thermal conductivity detector (5, 7) and which is adapted to detect the separated components and to generate a further detector signal (S11, S12) in response to each of the detected components; and
the evaluation unit (23) being further adapted to compare the detector signal (S5, S7) with the further detector signal (S11, S12) to recognize and signal a loss of or improper detection by the thermal conductivity detector (5, 7).

2. The gas chromatograph of claim 1, wherein the at least one further detector (11, 12) is identical in design to the thermal conductivity detector (5, 7).

3. The gas chromatograph of claim 1, wherein the sensing element (5′, 7′) of the thermal conductivity detector (5, 7) and the further sensing element (11′, 12′) of the at least one further thermal conductivity detector (11, 12) are thermally coupled on a common substrate.

4. The gas chromatograph of claim 2, wherein the sensing element (5′, 7′) of the thermal conductivity detector (5, 7) and the further sensing element (11′, 12′) of the at least one further thermal conductivity detector (11, 12) are thermally coupled on a common substrate.

5. The gas chromatograph of claim 1, wherein the sensing element (5′, 7′) of the thermal conductivity detector (5, 7) and the further sensing element (11′, 12′) of the at least one further thermal conductivity detector (11, 12) are integrated in a single component.

6. The gas chromatograph of claim 2, wherein the sensing element (5′, 7′) of the thermal conductivity detector (5, 7) and the further sensing element (11′, 12′) of the at least one further thermal conductivity detector (11, 12) are integrated in a single component.

7. The gas chromatograph of claim 1, wherein the sensing element (7′) of the thermal conductivity detector (7) and the further sensing element (12′) of the at least one further thermal conductivity detector (12) each have at least one heated filament (13, 15) in a tubular channel (17).
